(19) United States
(12) Patent Application Publication
(10) Pub. No.: US 2025/0338048 A1
(43) Pub. Date: Oct. 30, 2025

(54) OLT AND PON SYSTEM

(71) Applicant: Fujitsu Limited, Kawasaki-shi (JP)

(72) Inventor: Kazuto NISHIMURA, Yokohama (JP)

(73) Assignee: Fujitsu Limited, Kawasaki-shi (JP)

(21) Appl. No.: 19/060,031

(22) Filed: Feb. 21, 2025

(30) Foreign Application Priority Data
Apr. 24, 2024 (JP) 2024-070866

(51) Int. Cl. H04Q 11/00

(52) U.S. Cl. CPC H04Q 11/0067; H04Q 11/0066; H04Q 2011/0064; H04Q 2011/0079

(57) ABSTRACT

An OLT used for a PON using an optical splitter includes processing circuitry. The processing circuitry is configured to collect time information regarding arrival of packets from an ONU and amount-of-data information of the packets. The processing circuitry is configured to determine transmission timing of the ONU based on transmission timing information allocated to the ONU, the time information, and the amount-of-data information.

### CROSS-REFERENCE TO RELATED APPLICATION

This application is based upon and claims the benefit of priority of the prior Japanese Patent Application No. 2024-070866, filed on Apr. 24, 2024, the entire contents of which are incorporated herein by reference.

### FIELD

The embodiment discussed herein is related to an OLT and a PON system.

### BACKGROUND

As main requirements of 5G, for example, concepts of large capacity, low latency, and multiple connection have been newly born; the importance of these concepts is increasing also in Beyond 5G (B5G) and 6G. In particular, “low latency” is a concept that has not been considered much in the past, and there are many cases where existing networks is not able to guarantee low latency of data.

As a network that is not able to guarantee low latency of data, for example, there is a passive optical network (PON). Thus, a mechanism of time-division multiplexing (TDM)-PON will now be described. FIG. 9A is an explanatory diagram illustrating an example of downlink traffic of a PON system 100, and FIG. 9B is an explanatory diagram illustrating an example of uplink traffic of the PON system 100.

The PON system 100 includes a plurality of subscriber terminals 110, a plurality of optical network units (ONUs) 120, an optical splitter 130, and an optical line terminal (OLT) 140.

The ONU 120 is an optical terminal device on the subscriber side to be connected to the accommodated subscriber terminal 110. The ONU 120 optically converts a packet from the accommodated subscriber terminal 110, and outputs the packet after optical conversion to the optical splitter 130. Further, the ONU 120 electrically converts packets from the optical splitter 130, refers to the headers of the packets after electrical conversion, discards the packets other than the packet addressed to itself, and receives the arrival packet addressed to itself.

The optical splitter 130 multiplexes packets from the ONUs 120, and outputs the packets after multiplexing to the OLT 140. Further, the optical splitter 130 copies packets from the OLT 140, and outputs the copied packets to the ONUs 120 in a branched manner.

The OLT 140 is an optical terminal device on the station side of a communication company to be connected to a not-illustrated core network. The OLT 140 outputs packets from the optical splitter 130 to the core network, and outputs packets from the core network to the optical splitter 130.

In the downlink traffic from the OLT 140 to the ONU 120, as illustrated in FIG. 9A, the optical splitter 130 copies packets from the OLT 140, and outputs the copied packets to all the ONUs 120. Each ONU 120 has a filtering function; and refers to the headers of the packets, discards all the arrival packets other than the packet addressed to itself, and receives the arrival packet addressed to itself.

In the uplink traffic from the ONU 120 to the OLT 140, as illustrated in FIG. 9B, each ONU 120 outputs packets in a time division manner. That is, each ONU 120 can output packets in a band allocated to itself, and therefore a packet collision between ONUs 120 can be avoided.

Further, in the TDM-PON, an fixed bandwidth allocation (FBA) scheme in which a band is fixedly allocated to each ONU 120 in advance is employed. FIG. 10 is an explanatory diagram illustrating an example of allocation bands of ONUs 120 based on the FBA scheme. It is assumed that the ONUs 120 include, for example, four ONUs 120 of #1 to #4. Then, it is assumed that the OLT 140 allocates a first band to the ONU 120 of #1, a second band to the ONU 120 of #2, a third band to the ONU 120 of #3, and a fourth band to the ONU 120 of #4. Then, for example, it is assumed that the ONUs 120 of #1, #2, and #3 have output packets in a first time zone, the ONUs 120 of #1 and #2 have output packets in a second time zone, and the ONUs 120 of #1, #2, #3, and #4 have output packets in a third time zone. That is, it is assumed that there is no output packet of the ONU 120 of #4 in the first time zone and there is no output packet of the ONU 120 of #3 or #4 in the second time zone.

In the FBA scheme, although a band is fixedly allocated to each ONU 120, there is no output packet of the ONU 120 of #4 in the first time zone, and there is no output packet of the ONU 120 of #3 or #4 in the second time zone; thus, unused unnecessary bands are generated.

Thus, a dynamic bandwidth allocation (DBA) scheme in which bands to be allocated to each ONU 120 are dynamically changed in order to avoid unused unnecessary bands is known. As a mechanism of DBA, each ONU 120 notifies the OLT 140 of the amount of data waiting to be transmitted, i.e., the amount of transmission packets accumulated in its own buffer, and on the basis of the amount of data waiting to be transmitted of each ONU 120, the OLT 140 adjusts bands to be allocated to each ONU 120. FIG. 11 is an explanatory diagram illustrating an example of allocation bands of ONUs 120 based on the DBA scheme. It is assumed that the ONUs 120 of #1, #2, and #3 have output packets in a first time zone, the ONUs 120 of #1 and #2 have output packets in a second time zone, and the ONUs 120 of #1, #2, #3, and #4 have output packets in a third time zone.

The OLT 140 receives, from each ONU 120, a transmission request (REPORT) including the amount of data waiting to be transmitted, and acquires, from the received transmission request, the amount of data waiting to be transmitted of each ONU 120. On the basis of the amount of data waiting to be transmitted of each ONU 120, the OLT 140 calculates allocation bands to be allocated to each ONU 120. Then, on the basis of the calculated allocation bands, the OLT 140 dynamically allocates allocation bands of each time zone to each ONU 120.

That is, the OLT 140 allocates free bands to the ONUs 120 of #1, #2, and #3 in the first time zone, allocates free bands to the ONUs 120 of #1 and #2 in the second time zone, and allocates free bands to the ONUs 120 of #1, #2, #3, and #4 in the third time zone. As a result, generation of unused bands in the PON system 100 can be suppressed.
Patent Literature 1: U.S. Patent Application Publication No. 2020/0092622
Patent Literature 2: Japanese Laid-open Patent Publication No. 2019-149738
Patent Literature 3: Japanese Laid-open Patent Publication No. 2018-74513
Patent Literature 4: U.S. Patent Application Publication No. 2022/0123837

However, in the PON system 100 employing the DBA scheme, it takes time to communicate a transmission request (REPORT), a response (GATE), etc. between the ONU 120 and the OLT 140, to calculate allocation bands in the OLT 140, etc. Therefore, since it takes time in this way, the PON system 100 is not suitable as, for example, a PON system of low-latency use cases in which radio is not used and low latency is requested, such as remote medical care and autonomous driving.

Thus, for example, a PON system in which, even in a general-purpose low-latency use case, a low-latency guarantee can be secured without needing a special interface or protocol while the mechanism of an existing PON system is used as it is is desired.

### SUMMARY

According to an aspect of an embodiment, an OLT used for a PON using an optical splitter includes processing circuitry. The processing circuitry is configured to collect time information regarding arrival of packets from an ONU and amount-of-data information of the packets. The processing circuitry is configured to determine transmission timing of the ONU based on transmission timing information allocated to the ONU, the time information, and the amount-of-data information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a PON system of the present embodiment;

FIG. 2 is a block diagram illustrating an example of an OLT;

FIG. 3 is an explanatory diagram illustrating an example of an intermediate packet group and a head packet group;

FIG. 4 is an explanatory diagram illustrating an example of allocation timing before allocation of an ONU of a low-latency request;

FIG. 5 is an explanatory diagram illustrating an example of allocation timing before and after allocation of an ONU of a low-latency request;

FIG. 6 is a flowchart illustrating an example of a processing operation of the OLT related to allocation processing;

FIG. 7 is a flowchart illustrating an example of a processing operation of the OLT related to determination processing;

FIG. 8 is an explanatory diagram illustrating an example of a comparison result of latency, jitter, and the presence or absence of an unused band between the present embodiment, the DBA scheme, and the FBA scheme;

FIG. 9A is an explanatory diagram illustrating an example of downlink traffic of a PON system;

FIG. 9B is an explanatory diagram illustrating an example of uplink traffic of the PON system;

FIG. 10 is an explanatory diagram illustrating an example of allocation bands of ONUs based on the FBA scheme; and

FIG. 11 is an explanatory diagram illustrating an example of allocation bands of ONUs based on the DBA scheme.

### DESCRIPTION OF EMBODIMENT

Preferred embodiment of the present invention will be explained with reference to accompanying drawings. The disclosed technology is not limited by the embodiments. The embodiments described below may be combined as appropriate to the extent that no contradiction is caused.

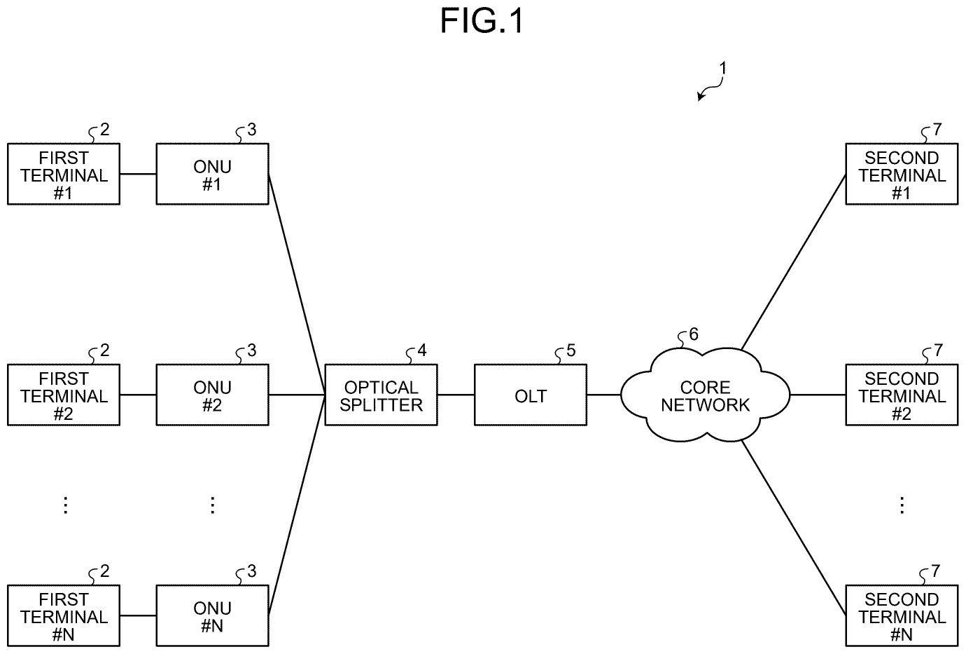

FIG. 1 is an explanatory diagram illustrating an example of a PON system 1 of the present embodiment. The PON system 1 illustrated in FIG. 1 includes a plurality of first terminals 2, a plurality of optical network units (ONUs) 3, an optical splitter 4, an optical line terminal (OLT) 5, a core network 6, and a plurality of second terminals 7.

The first terminal 2 is a terminal device on the subscriber side that communicates and connects to the ONU 3. The ONU 3 is an optical termination device on the subscriber side that communicates and connects to the first terminal 2. For convenience of description, it is assumed that, for example, the number of ONUs 3 is N and the ONUs 3 include the ONU 3 of #1, the ONU 3 of #2, the ONU 3 of #3, the ONU 3 of #N, etc.

The ONU 3 optically converts a packet from the accommodated first terminal 2, and outputs the packet after optical conversion to the optical splitter 4. Further, the ONU 3 electrically converts packets from the optical splitter 4, refers to the headers of the arrival packets after electrical conversion, discards the arrival packets other than the packet addressed to itself, and receives the arrival packet addressed to itself.

In the case where the ONU 3 has received a packet from the first terminal 2 within allocation timing allocated to itself by the OLT 5, the ONU 3 outputs the received packet to the OLT 5 via the optical splitter 4. In contrast, in the case where the ONU 3 has received a packet from the first terminal 2 outside the allocation timing of itself, the ONU 3 buffers the received packet. Then, when the allocation timing of itself has come, the ONU 3 outputs the buffered packet from the first terminal 2 to the OLT 5 via the optical splitter 4.

The optical splitter 4 is placed between the N ONUs 3 and the OLT 5; and multiplexes optical signals of packets from each ONU 3, and outputs the optical signal of the packets after multiplexing to the OLT 5. The optical splitter 4 copies an optical signal from the OLT 5, and outputs the optical signals after copying to each ONU 3 in a branched manner.

The OLT 5 is placed between the core network 6 and the optical splitter 4, and is an optical terminal device on the communication company side of the core network 6. The OLT 5 outputs packets from the optical splitter 4 to the core network 6, and outputs packets from the core network 6 to the optical splitter 4.

The traffic from the ONU 3 to the OLT 5 is referred to as uplink traffic, and the traffic from the OLT 5 to the ONU 3 is referred to as downlink traffic. The PON system 1 of the present embodiment has a mechanism for achieving low latency of packets in units of ONUs 3 in uplink traffic. Examples of the packet of which low latency is needed include communication packets having periodicity that flow between a first terminal 2 such as an operating terminal that remotely operates a medical device and a second terminal 7 such as a medical device. For example, it is assumed that the first terminal 2 remotely operates the second terminal 7 through the ONU 3, the optical splitter 4, the OLT 5, and the core network 6 in this order.

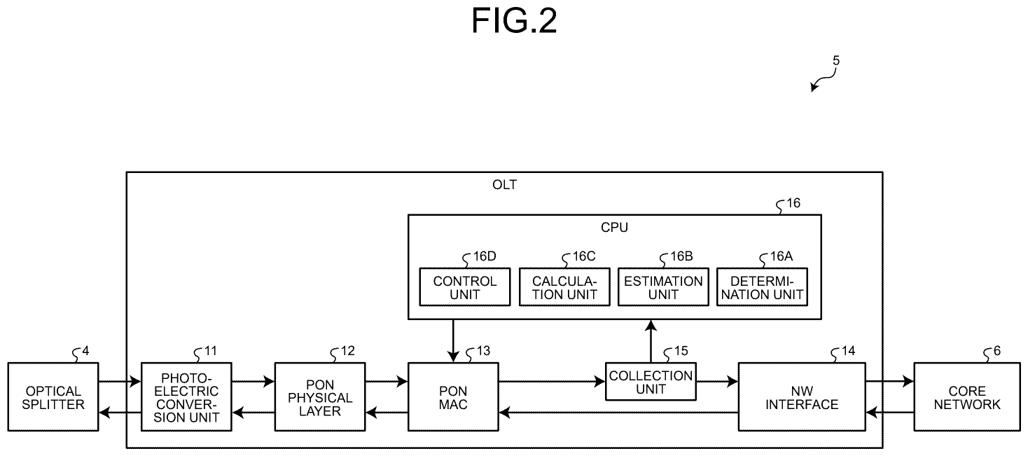

FIG. 2 is a block diagram illustrating an example of the OLT 5. The OLT 5 illustrated in FIG. 2 includes a photoelectric conversion unit 11, a PON physical layer 12, a PON MAC 13, an NW interface 14, a collection unit 15, and a central processing unit (CPU) 16.

The photoelectric conversion unit 11 is connected to an optical fiber of the PON connected to the optical splitter 4; and electrically converts packets from the ONU 3, and optically converts packets to the ONU 3. The PON physical layer 12 executes physical layer processing on a packet received from the ONU 3, and executes physical layer processing on a packet to be transmitted to the ONU 3. The physical layer processing is, for example, processing based on a PON standard such as IEEE 802.3ah.

The PON MAC 13 executes MAC layer processing on a packet from the ONU 3, and executes MAC layer processing on a packet to the ONU 3. The MAC layer processing is, for example, processing based on a PON standard such as IEEE 802.3ah. The MAC layer processing is, for example, processing of executing instructions of allocation timing including transmission start times, the amounts of transmission, allocation bands, allocation periods of time, etc. for each ONU 3. The NW interface 14 is a communication interface connected to the core network 6.

The collection unit 15, in the case where an ONU 3 is an object of a low-latency request, monitors uplink traffic from ONUs 3 to the OLT 5, and collects packet information, for example the arrival times and the amounts of data, of arrival packets from each ONU 3.

The CPU 16 is an example of a processing unit, and includes a determination unit 16A, an estimation unit 16B, a calculation unit 16C, and a control unit 16D. Regarding the determination unit 16A, on the basis of the allocation timing of the ONU 3 of a low-latency request and the arrival times and the amounts of data of arrival packets of the ONU 3 of a low-latency request collected by the collection unit 15, the determination unit 16A executes determination processing of determining whether an arrival packet is of a head packet group or of an intermediate packet group. The allocation timing is, for example, allocation periods of time and transmission start times. The allocation period of time is a time zone that can be used for packet communication of the ONU 3 in uplink traffic. The transmission start time is a time at which packet communication of the ONU 3 in uplink traffic is started.

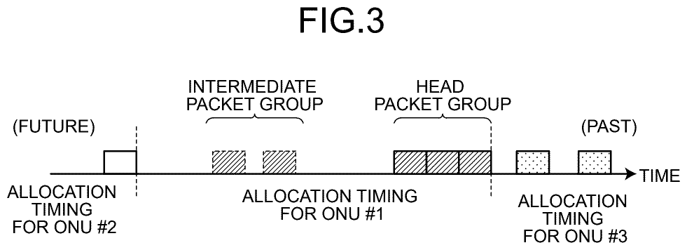

Here, the head packet group and the intermediate packet group will now be described. FIG. 3 is an explanatory diagram illustrating an example of the intermediate packet group and the head packet group. In the example illustrated in FIG. 3, for example, it is assumed that, after an allocation period of time of allocation timing of the ONU 3 of #3, an allocation period of time of allocation timing of the ONU 3 of #1 comes, and then an allocation period of time of allocation timing of the ONU 3 of #2 comes. The allocation period of time is a period allocated to the ONU 3, and is a period in which arrival packets arriving at the ONU 3 can be preferentially outputted to the OLT 5.

When attention is focused on the allocation period of time of the ONU 3 of #1, an arrival packet group that arrives in a burst manner immediately after the start of the allocation period of time is defined as a head packet group. In contrast, an arrival packet group that arrives discretely during the allocation period of time except immediately after the start of the allocation period of time is defined as an intermediate packet group.

It can be said that the head packet group that arrives in a burst manner immediately after the start of the allocation period of time of the ONU 3 of #1 is arrival packets that arrived at the ONU 3 of #1 from the first terminal 2 of #1 during an allocation period of time of another ONU 3 of #2 or #3 and that have been buffered in the ONU 3 of #1. That is, it can be presumed that the head packet group is arrival packets that are buffered and that are to be preferentially outputted from the ONU 3 of #1 to the OLT 5 upon coming of an allocation period of time of the buffered arrival packets. Therefore, it can be said that the head packet group is an arrival packet group that has large latency and for which a low-latency guarantee is not secured.

Further, it can be presumed that the intermediate packet group that arrives discretely during the allocation period of time is arrival packets that come from the first terminal 2 of #1 and that arrive at the OLT 5 from the ONU 3 of #1 as they are without being buffered in the ONU 3 of #1. Therefore, it can be said that the intermediate packet group is an arrival packet group that has small latency and for which a low-latency guarantee is secured.

From the viewpoint of low latency, it can also be said that the arrival timing of the intermediate packet group that arrives discretely during the allocation period of time, that is, arrival packets that arrive at the OLT 5 from the ONU 3 as they are without being buffered in the ONU 3 is the optimum timing in which a low-latency guarantee is secured.

On the basis of a collection result of the collection unit 15, in the case where the arrival time of an arrival packet is the head of the allocation timing of the ONU 3 of a low-latency request, the determination unit 16A determines that the arrival packet is a head packet. Further, in the case where there is a next arrival packet within the allocation timing, the determination unit 16A determines whether the interval between the immediately preceding arrival packet and the next arrival packet is zero or not. In the case where the interval is zero, the determination unit 16A determines that the arrival packet is a head packet, and determines that the arrival packet is of a head packet group similarly to the immediately preceding head packet. Further, from transmission timing information and time information, it is perceived that the head packet is a packet transmitted at the allocation start time in one piece of the allocation timing allocated to the ONU 3.

In the case where the arrival time of an arrival packet is not the head of the allocation timing of the ONU 3 of a low-latency request, that is, an intermediate in the allocation timing, the determination unit 16A determines that the arrival packet is an intermediate packet, and determines whether there is a next arrival packet within the allocation timing or not. Then, the determination unit 16A determines that the next arrival packet within the allocation timing is an intermediate packet, and determines that the next arrival packet is of an intermediate packet group similarly to the immediately preceding intermediate packet.

The estimation unit 16B acquires, on the basis of the determination result of the determination unit 16A, the head time T1 of the first intermediate packet group and the head time T2 of the second intermediate packet group. Further, the estimation unit 16B acquires the amount of data b of head packet groups between the first intermediate packet group and the second intermediate packet group and the amount of data a of the first intermediate packet group.

The estimation unit 16B obtains an integer value c of an approximation of (the amount of data b of head packet groups ÷ the amount of data a of the first intermediate packet group). Then, on the basis of (T2−T1)/(c+1), the estimation unit 16B estimates an output cycle Tc of packets from the first terminal 2 of a low-latency request. It can be said that the output cycle Tc is an output cycle of packets outputted by the first terminal 2 of a low-latency request. It can also be said that the output cycle Tc is a transmission allocation cycle of the ONU 3 connected to the first terminal 2 of a low-latency request. The amount of data a of the first intermediate packet group used to obtain the integer value c may be the amount of data of the second intermediate packet group, and can be changed as appropriate.

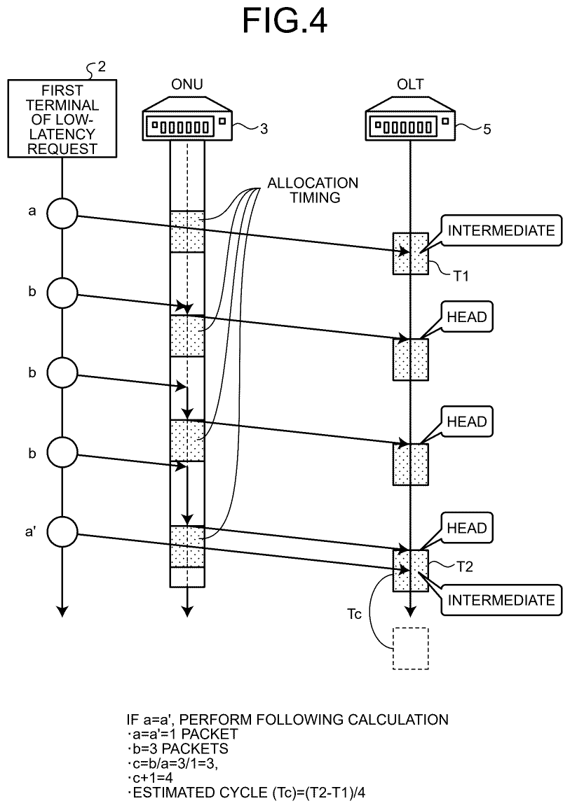

FIG. 4 is an explanatory diagram illustrating an example of allocation timing before allocation of an ONU 3 of a low-latency request. The ONU 3 receives packets from the accommodated first terminal 2. The ONU 3 outputs packets from the first terminal 2 to the OLT 5 in each piece of the allocation timing. In the case where the timing at which a packet is received from the first terminal 2 is not the allocation timing of itself, the ONU 3 buffers the received packet, and is to preferentially output the buffered packet to the OLT 5 at the timing at which the next allocation timing comes.

Thus, in the case where a low-latency request is detected from an ONU 3, the OLT 5 sequentially receives arrival packets in pieces of the allocation timing of the ONU 3 of a low-latency request. At this time, the OLT 5 illustrated in FIG. 4 receives the first intermediate packet group in the first piece of the allocation timing, receives the first head packet group in the second piece of the allocation timing, and receives the second head packet group in the third piece of the allocation timing. Further, it is assumed that the OLT 5 receives the third head packet group in the fourth piece of the allocation timing and receives the second intermediate packet group in the fifth piece of the allocation timing.

The estimation unit 16B acquires the head time T1 of the first intermediate packet group and the head time T2 of the second intermediate packet group. Further, the estimation unit 16B acquires the amount of data a of the first intermediate packet group and the amount of data b of the three head packet groups between the first intermediate packet group and the second intermediate packet group. It is assumed that the amount of data a of the first intermediate packet group is one packet and the amount of data b of the three head packet groups is three packets. The integer value c is b/a=3/1=3. That is, the output cycle Tc of the first terminal 2 of a low-latency request is (T2−T1)/(3+1).

Regarding the calculation unit 16C, on the basis of the output cycle Tc of the first terminal 2 of a low-latency request estimated by the estimation unit 16B, the calculation unit 16C calculates, as allocation timing for the ONU 3 of a low-latency request, allocation bands, transmission start times, and allocation periods of time. Specifically, on the basis of (T2+Tc×X>current time), the calculation unit 16C calculates allocation timing at and after the current time for the ONU 3 of a low-latency request. It can be said that the allocation timing is a transmission allocation phase of the ONU 3. Further, it can be said that the allocation timing is transmission timing with which all arrival packets in each piece of allocation timing from the ONU 3 of a low-latency request are allowed to be an intermediate packet group.

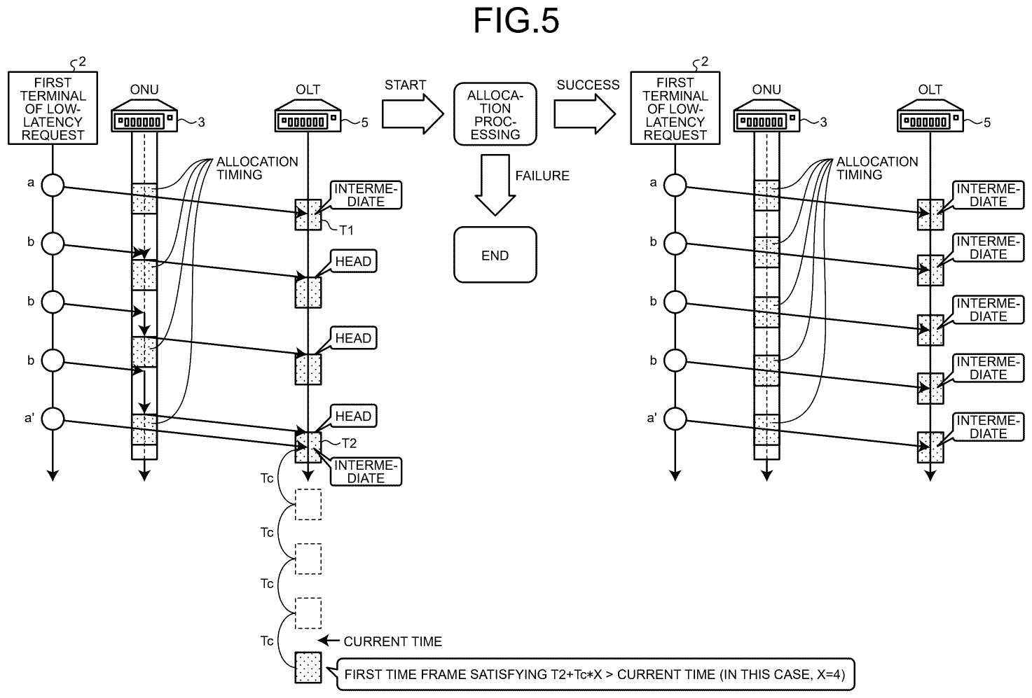

FIG. 5 is an explanatory diagram illustrating an example of allocation timing before and after allocation of an ONU 3 of a low-latency request. On the basis of (T2+Tc×X>current time), the calculation unit 16C calculates allocation timing at and after the current time for the ONU 3 of a low-latency request. In the example illustrated in FIG. 5, X is four. Further, pieces of allocation timing are allocated to the ONU 3 of a low-latency request at intervals of Tc thereafter.

In the case where the allocation timing of allocation processing has succeeded, the OLT 5 allocates allocation timing to the ONU 3 of a low-latency request. On the basis of the allocation timing, the ONU 3 of a low-latency request sequentially outputs packets from the first terminal 2 of a low-latency request to the OLT 5 as they are without buffering the packets from the first terminal 2. As a result, all arrival packets from the first terminal 2 of a low-latency request are received as intermediate packets, and therefore the OLT 5 can secure low-latency packet communication with the first terminal 2.

In the case where the allocation timing of allocation processing has failed, the OLT 5 determines that low latency is not able to be guaranteed, and ends the allocation processing.

The control unit 16D uses the PON MAC 13 to notify the ONU 3 of a low-latency request of the calculated allocation timing. On the basis of the allocated allocation timing, the ONU 3 outputs arrival packets from the first terminal 2 to the OLT 5. As a result, the ONU 3 of a low-latency request can output arrival packets from the first terminal 2 to the OLT 5 without buffering the arrival packets, and therefore low latency of packets from the ONU 3 of a low-latency request can be guaranteed.

Using the DBA scheme, the control unit 16D allocates allocation timing of the ONUs 3 other than the ONU 3 of a low-latency request from the remaining timing other than the allocation timing of the ONU 3 of a low-latency request by using transmission start times and the amounts of transmission included in information from the PON MAC 13, etc.

The control unit 16D uses the PON MAC 13 to notify the ONUs 3 other than the ONU 3 of a low-latency request of the allocation timing. On the basis of the received allocation timing, each ONU 3 outputs, to the OLT 5, arrival packets from the first terminal 2 accommodated by itself. As a result, each of the ONUs 3 other than the ONU 3 of a low-latency request outputs arrival packets from the accommodated first terminal 2 to the OLT 5 on the basis of the allocation timing allocated by the DBA scheme.

In packet communication with an ONU 3 of which low latency is not requested among the plurality of ONUs 3, the OLT 5 receives arrival packets from the first terminal 2 with allocation timing of the ONU 3 using the existing DBA scheme. In contrast, in packet communication with an ONU 3 of which low latency is requested among the plurality of ONUs 3, the OLT 5 receives arrival packets from the first terminal 2 of a low-latency request with allocation timing of the ONU 3 using the scheme of the present embodiment.

Next, an operation of the PON system 1 of the present embodiment is described. First, in the PON system 1, it is assumed that packet communication in which low latency is requested is made at a predetermined cycle between the first terminal 2 accommodated by, for example, the ONU 3 of #1 among the plurality of ONUs 3 and the second terminal 7.

First, it is assumed that the OLT 5 has allocated allocation bands to the ONUs 3 fixedly and evenly like in the FBA scheme. At this time, the cycle and phase of the allocation band allocated by the FBA scheme may be arbitrary values.

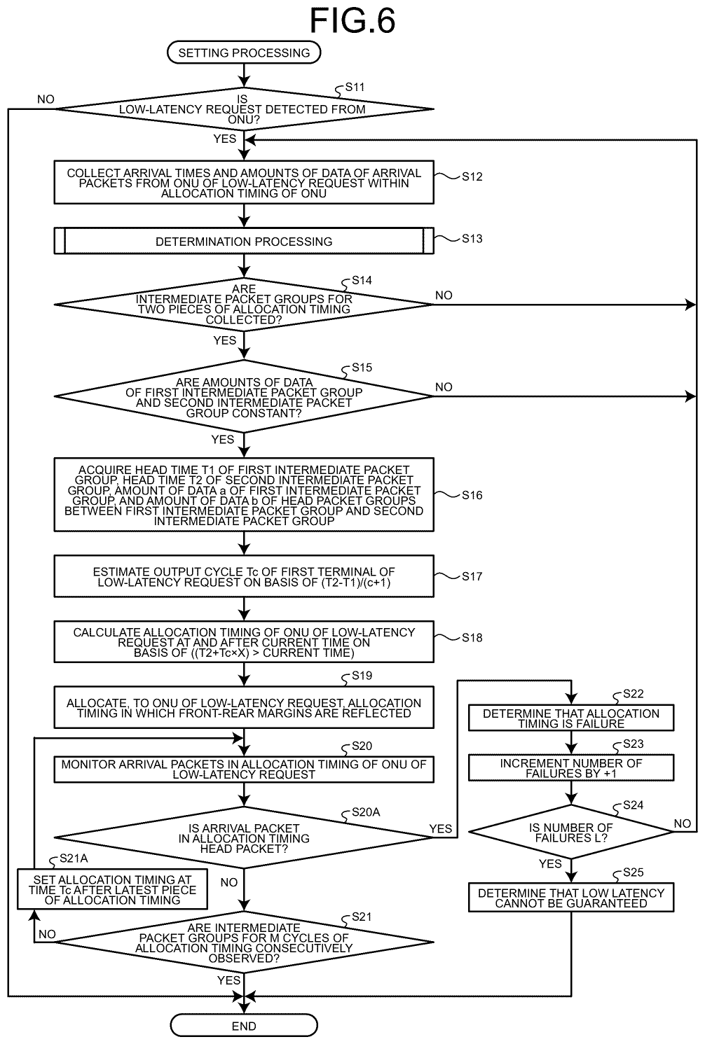

FIG. 6 is a flowchart illustrating an example of a processing operation of the OLT 5 related to allocation processing. In FIG. 6, the OLT 5 determines whether a low-latency request is detected from an ONU 3 of a low-latency request or not (Step S11). The ONU 3 of a low-latency request is an ONU 3 that accommodates a first terminal 2 of which low-latency packet communication is requested.

In the case where a low-latency request is detected (Step S11: Yes), the collection unit 15 in the OLT 5 collects the arrival times and the amounts of data of arrival packets from the ONU 3 of a low-latency request within allocation timing of the ONU 3 (Step S12).

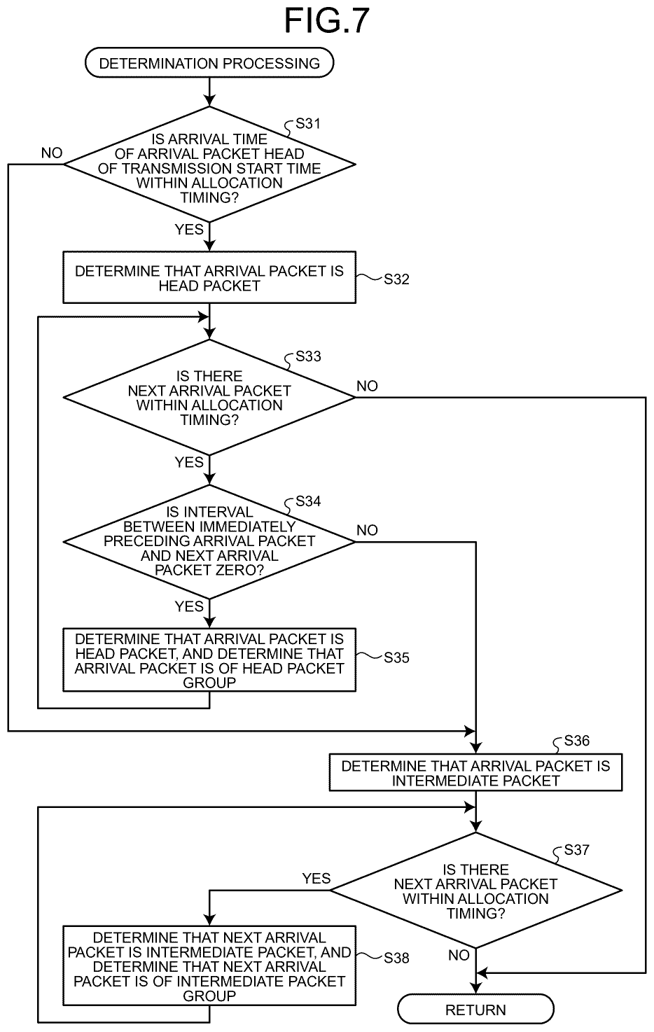

The determination unit 16A in the OLT 5 acquires allocation timing of the ONU 3 of a low-latency request, and the arrival times and the amounts of data of arrival packets collected within the allocation timing. On the basis of the acquisition result, the determination unit 16A executes determination processing illustrated in FIG. 7 of determining, for each arrival packet, whether the arrival packet is of a head packet group or of an intermediate packet group (Step S13).

The estimation unit 16B in the OLT 5 determines whether intermediate packet groups for two pieces of the allocation timing of the ONU 3 of a low-latency request are collected or not (Step S14). In the case where intermediate packet groups for two pieces of the allocation timing are collected (Step S14: Yes), the CPU 16 determines whether the amounts of data of the first intermediate packet group and the second intermediate packet group are constant or not (Step S15).

In the case where the amounts of data of the first intermediate packet group and the second intermediate packet group are constant (Step S15: Yes), the CPU 16 acquires information used to calculate an output cycle of the first terminal 2 of a low-latency request (Step S16). The information used to calculate the output cycle includes the head time T1 of the first intermediate packet group and the head time T2 of the second intermediate packet group. Further, the information used to calculate the output cycle includes the amount of data a of the first intermediate packet group, the amount of data b of head packet groups between the first intermediate packet group and the second intermediate packet group, etc. The integer value c is an integer value of an approximation of b/a.

On the basis of (T2−T1)/(c+1), the estimation unit 16B estimates an output cycle Tc of the first terminal 2 of a low-latency request (Step S17).

On the basis of (T2+Tc×X>current time), the calculation unit 16C calculates allocation timing of the ONU 3 of a low-latency request at and after the current time (Step S18).

The calculation unit 16C causes front-rear margins to be reflected in the calculated allocation timing of the ONU 3 of a low-latency request at and after the current time, and allocates, to the ONU 3 of a low-latency request, the allocation timing in which the front-rear margins are reflected (Step S19).

After the allocation timing is allocated, the control unit 16D monitors arrival packets in the allocation timing of the ONU 3 of a low-latency request (Step S20). On the basis of the result of monitoring of arrival packets, the control unit 16D determines whether an arrival packet in the allocation timing is a head packet or not (Step S20A).

In the case where the arrival packet in the allocation timing is not a head packet (Step S20A: No), the control unit 16D determines that the arrival packet is an intermediate packet, and determines whether intermediate packet groups for M cycles of the allocation timing are consecutively observed or not (Step S21).

In the case where intermediate packet groups for M cycles of the allocation timing are consecutively observed (Step S21: Yes), the control unit 16D determines that the allocation is success, and ends the processing operation illustrated in FIG. 6.

In the case where intermediate packet groups for M cycles of the allocation timing are not consecutively observed (Step S21: No), the control unit 16D sets an allocation timing at the time Tc after the latest piece of the allocation timing (Step S21A), and then proceeds to the processing of Step S20 in order to determine whether an arrival packet in the allocation timing is a head packet or not.

In the case where the arrival packet in the allocation timing is a head packet (Step S20A: Yes), the control unit 16D determines that the allocation timing is failure (Step S22), and increments the number of failures by +1 (Step S23).

The control unit 16D determines whether the number of failures is L or not (Step S24). In the case where the number of failures is L (Step S24: Yes), the control unit 16D determines that low latency is not able to be guaranteed (Step S25), and ends the processing operation illustrated in FIG. 6. In the case where a low-latency request is not detected (Step S11: No), the OLT 5 ends the processing operation illustrated in FIG. 6.

In the case where the number of failures is not L (Step S24: No), the control unit 16D returns to the processing of Step S12 in order to collect information of arrival packets within allocation timing. In the case where intermediate packet groups for two pieces of the allocation timing are not collected (Step S14: No), the estimation unit 16B returns to the processing of Step S12 in order to collect information of arrival packets within allocation timing. In the case where the amounts of data of the first intermediate packet group and the second intermediate packet group are not constant (Step S15: No), the estimation unit 16B returns to the processing of Step S12 in order to collect information of arrival packets within allocation timing.

FIG. 7 is a flowchart illustrating an example of a processing operation of the OLT 5 related to determination processing. In FIG. 7, the determination unit 16A in the OLT 5 determines whether the arrival time of an arrival packet is the head of a transmission start time within the allocation timing or not (Step S31). In the case where the arrival time is the head of a transmission start time (Step S31: Yes), the determination unit 16A determines that the arrival packet is a head packet (Step S32).

The determination unit 16A determines whether there is a next arrival packet within the allocation timing or not (Step S33). In the case where there is a next arrival packet (Step S33: Yes), the determination unit 16A determines whether the interval between the immediately preceding arrival packet and the next arrival packet is zero or not (Step S34).

In the case where the interval between the immediately preceding arrival packet and the next arrival packet is zero (Step S34: Yes), the determination unit 16A determines that the arrival packets are consecutive head packets, and determines that the packets are a head packet group (Step S35). Then, the determination unit 16A returns to the processing of Step S33 in order to determine whether there is a next arrival packet or not.

In the case where the interval between the immediately preceding arrival packet and the next arrival packet is not zero (Step S34: No), the determination unit 16A determines that the arrival packets are intermediate packets (Step S36). The determination unit 16A determines whether there is a next arrival packet within the allocation timing or not (Step S37).

In the case where there is a next arrival packet within the allocation timing (Step S37: Yes), the determination unit 16A determines that the next arrival packet is a consecutive intermediate packet, and determines that the next arrival packet is of an intermediate packet group (Step S38). Then, the determination unit 16A returns to the processing of Step S37 in order to determine whether there is a next arrival packet within the allocation timing or not.

In the case where the arrival time is not the head of a transmission start time (Step S31: No), the determination unit 16A proceeds to the processing of Step S36 in order to determine that the arrival packet is an intermediate packet. In the case where there is no next arrival packet (Step S33: No), the determination unit 16A ends the processing operation illustrated in FIG. 7. In the case where there is no next arrival packet within the allocation timing (Step S37: No), the determination unit 16A ends the processing operation illustrated in FIG. 7.

Next, an operation in the case of requesting low latency of packet communication of the first terminal 2 of #1 is described. It is assumed that the OLT 5 has detected a low-latency request from the ONU 3 of #1 among the plurality of ONUs 3. In the case where a low-latency request is detected from the ONU 3 of #1, the collection unit 15 of the OLT 5 collects information of arrival packets from the ONU 3 of #1 in each piece of allocation timing of the ONU 3 of #1.

On the basis of the result of collection of arrival packets from the ONU 3 of #1, the determination unit 16A of the OLT 5 determines, for each arrival packet within the allocation timing of the ONU 3 of #1, whether the arrival packet is of a head packet group or of an intermediate packet group.

The estimation unit 16B of the OLT 5 acquires the head time T1 of the first intermediate packet group and the head time T2 of the second intermediate packet group related to allocation timing of the ONU 3 of #1. The estimation unit 16B acquires the amount of data b of head packet groups between the first intermediate packet group and the second intermediate packet group and the amount of data a of the first intermediate packet group. Then, on the basis of (T2−T1)/(c+1), the estimation unit 16B estimates an output cycle Tc of the first terminal 2 of #1 of a low-latency request.

On the basis of the head time T2 of the second intermediate packet group and the output cycle Tc of the first terminal 2 of #1, the calculation unit 16C in the OLT 5 calculates allocation timing (T2+Tc×X>current time) at and after the current time for the ONU 3 of #1.

Then, the control unit 16D in the OLT 5 notifies the ONU 3 of #1 of a low-latency request of the calculated allocation timing. Then, on the basis of the allocation timing, the ONU 3 of #1 outputs arrival packets from the first terminal 2 to the OLT 5.

In the case where a case where all arrival packets in the allocation timing from the ONU 3 of #1 of a low-latency request are intermediate packets is observed consecutively for M cycles, the control unit 16D determines that the allocation of allocation timing of the ONU 3 of #1 is success.

However, in the case where a case where all arrival packets in the allocation timing from the ONU 3 of #1 of a low-latency request are intermediate packets is not observed consecutively for M cycles, the control unit 16D increments the number of failures by +1. After incrementing the number of failures by +1, the estimation unit 16B again acquires the first intermediate packet group and the second intermediate packet group related to the ONU #1 in the allocation timing currently allocated. Further, the estimation unit 16B acquires the amount of data b of head packets between the first intermediate packet group and the second intermediate packet group and the amount of data a of the first intermediate packet group. Then, the estimation unit 16B estimates an output cycle Tc of the first terminal 2 of #1 again.

Then, on the basis of the output cycle of the first terminal 2 of #1 and the head time of the second intermediate packet, the calculation unit 16C calculates allocation timing at and after the current time for the ONU 3 of #1. Then, the control unit 16D notifies the ONU 3 of #1 of the calculated allocation timing at and after the current time of the ONU 3 of #1. Then, on the basis of the allocation timing, the ONU 3 of #1 outputs arrival packets from the first terminal 2 to the OLT 5. Then, the control unit 16D determines whether a case where all arrival packets in the allocation timing from the ONU 3 of #1 of a low-latency request are intermediate packets is observed consecutively for M cycles or not. In the case where a case where all arrival packets in the allocation timing from the ONU 3 of #1 of a low-latency request are intermediate packets is observed consecutively for M cycles, the control unit 16D determines that the allocation timing of the ONU 3 of #1 is success.

In the case where a case where all arrival packets in the allocation timing from the ONU 3 of #1 of a low-latency request are intermediate packets is not observed consecutively for M cycles, the control unit 16D increments the number of failures by +1. After incrementing the number of failures by +1, the control unit 16D determines whether the number of failures is L or not.

In the case where the number of failures is L, the control unit 16D determines that there is no periodicity of arrival packets from the ONU 3 of #1, and ends the processing for calculating allocation timing of the ONU 3 of #1. That is, it is determined that low latency for the ONU 3 of #1 is not able to be guaranteed.

The OLT 5 of a first embodiment can achieve a low-latency guarantee in the PON system 1 by adjusting the allocation timing of the ONU 3 of a low-latency request such that all arrival packets outputted from the ONU 3 of a low-latency request are an intermediate packet group.

The OLT 5 collects packet information of arrival packets from the ONU 3 of a low-latency request that arrive within allocation timing allocated to the ONU 3. On the basis of the collection result, the OLT 5 determines whether an arrival packet is a head packet that arrives immediately after the start of the allocation timing or an intermediate packet that arrives during the allocation timing except immediately after the start of the allocation timing. On the basis of the determination result, the OLT 5 acquires the head time T1 of the first intermediate packet group, the head time T2 of the second intermediate packet group, the amount of data b of head packets between the first intermediate packet group and the second intermediate packet group, and the amount of data a of the intermediate packets. On the basis of (T2−T1)/(c+1), the OLT 5 estimates an output cycle Tc of the first terminal 2 of a low-latency request. Then, on the basis of the estimated output cycle Tc, the OLT 5 calculates allocation timing to be allocated to the ONU 3 of a low-latency request. As a result, a low-latency guarantee in the PON system 1 can be achieved.

On the basis of the output cycle Tc, the OLT 5 calculates allocation timing with which all head packets between the first intermediate packet group and the second intermediate packet group are turned to intermediate packets. As a result, the allocation timing is in agreement with the output cycle of packets from the first terminal 2 of a low-latency request, and therefore the ONU 3 of a low-latency request can output arrival packets from the first terminal 2 to the OLT 5 without buffering the arrival packets.

In the case where a low-latency request from any ONU 3 among a plurality of ONUs 3 is detected, the OLT 5 starts an operation of collecting arrival packets that arrive within allocation timing allocated to the ONU 3 that requests low latency. As a result, allocation processing can be executed exclusively on the ONU 3 that requests low latency.

After the calculated allocation timing is allocated to the ONU 3, in the case where an event where an arrival packet in the allocation timing is observed as an intermediate packet appears consecutively M times, the OLT 5 determines that the allocation timing is success. As a result, reliable allocation timing can be secured.

After the calculated allocation timing is allocated to the ONU 3, in the case where an arrival packet in each piece of the allocation timing is determined as a head packet, the OLT 5 determines that the allocation timing is failure. As a result, reliable allocation timing can be secured.

In the case where it is determined that the allocation timing is failure, the OLT 5 increments the number of failures by +1, and resumes the collection operation of collecting packet information of arrival packets from the ONU 3 that arrive within allocation timing until the number of failures exceeds a predetermined number. As a result, a retrying operation for obtaining allocation timing can be executed.

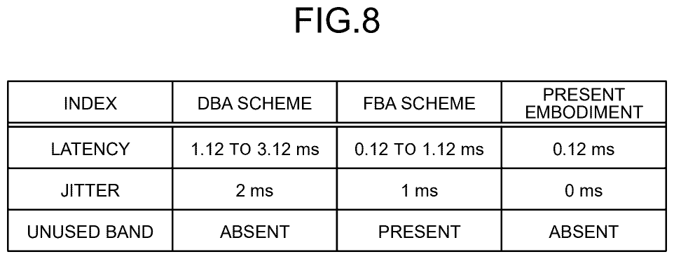

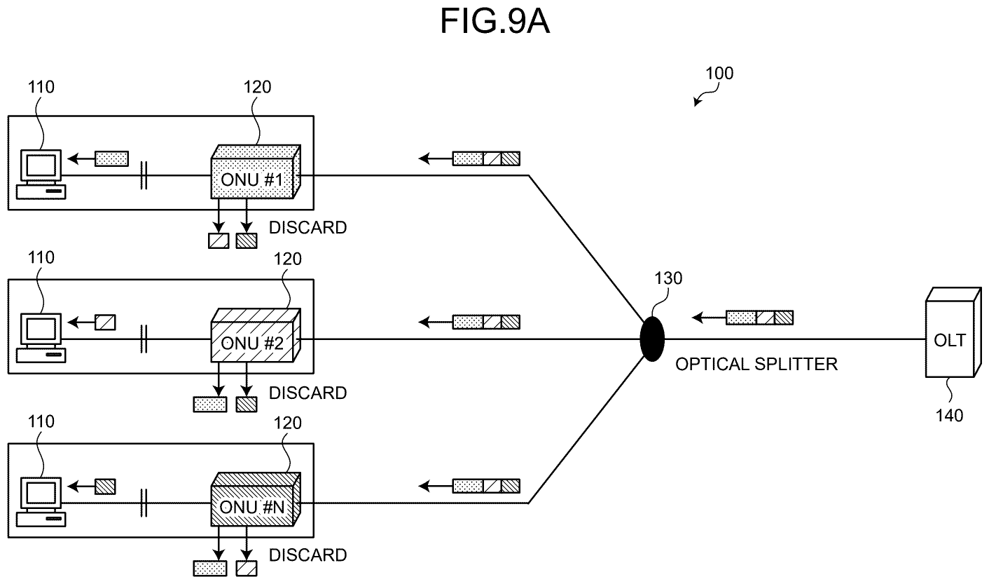

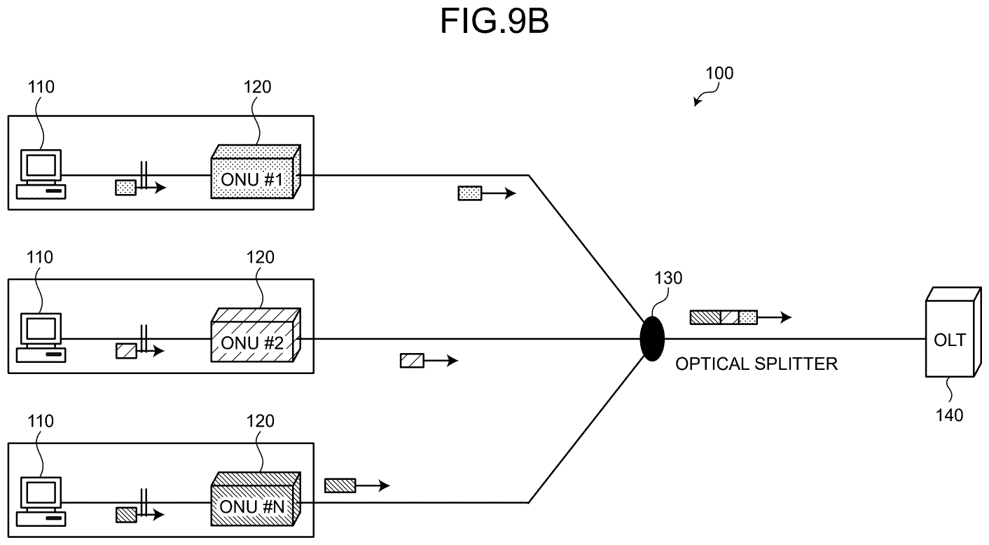

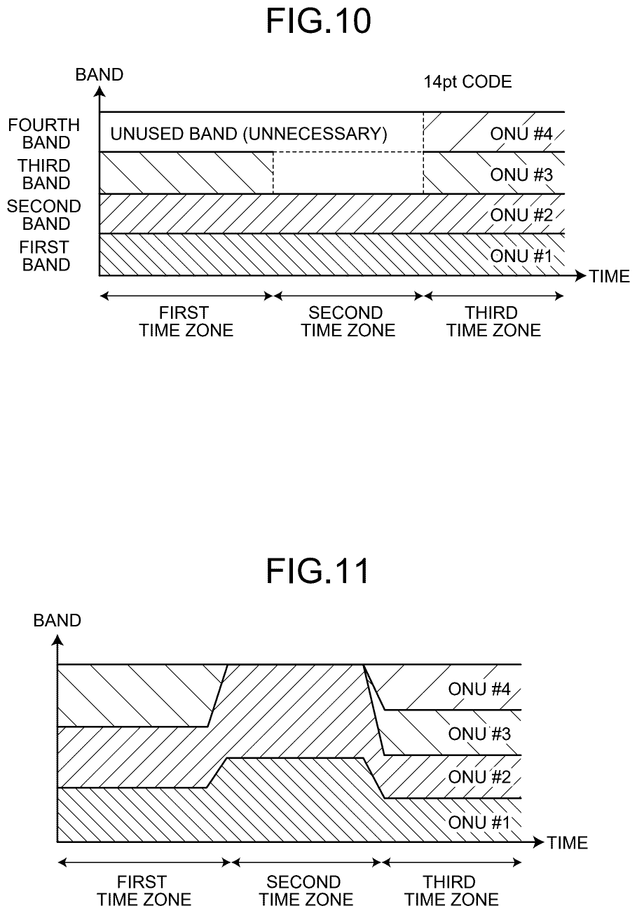

Here, comparison of performance between the PON system 1 of the present embodiment, and a PON system of the FBA scheme and a PON system of the DBA scheme of comparative examples will now be described. FIG. 8 is an explanatory diagram illustrating an example of a comparison result of latency, jitter, and the presence or absence of an unused band between the present embodiment, the DBA scheme, and the FBA scheme. For convenience of description, it is assumed that the processing latency inside the ONU is 10 μs, the propagation latency of the optical fiber between the ONU and the OLT is 100 μs (20 km), the processing latency inside the OLT is 10 μs, and the total fixed latency is 120 μs.

In the PON system of the DBA scheme of a comparative example, a cycle (DBA cycle) in which the OLT allocates bands to ONUs is set to 1 msec. In the OLT, a REPORT arrives from the ONU at an arbitrary time. At this time, in the REPORT, a latency of a minimum of 0 seconds, a maximum of 1 msec, and an average of 0.5 msec occurs.

The OLT of the PON system of the DBA scheme makes a band request by means of a REPORT from each ONU, performs DBA calculation, and notifies each ONU of allocation timing within the next DBA cycle by means of a GATE. As a result, in the PON system of the DBA scheme, waiting for a fixed period of time equal to one DBA cycle (1 msec) is caused. Therefore, the PON system of the DBA scheme depends on DBA calculation and congestion condition. At this time, in the DBA calculation, a latency of a minimum of 0 seconds, a maximum of 1 msec, and an average of 0.5 msec occurs.

Therefore, in the PON system of the DBA scheme, as illustrated in FIG. 8, the total latency is, for example, 1.12 msec to 3.12 msec (jitter: 2 msec).

Further, bands are fixedly allocated to ONUs of the PON system of the FBA scheme of a comparative example. However, there is no guarantee that the band is in agreement with the cycle of the application. A data packet arrives at an arbitrary time in the DBA cycle (1 msec). At this time, a latency of a minimum of 0 seconds, a maximum of 1 msec, and an average of 0.5 msec occurs. Therefore, in the PON system of the FBA scheme, as illustrated in FIG. 8, although the total latency is 0.12 msec to 1.12 msec (jitter: 1 msec), an unused unnecessary band is generated.

In contrast, in the PON system 1 of the present embodiment, the DBA cycle is set to 1 msec likewise. In the PON system 1, the allocation timing of an ONU 3 that has made a low-latency request is adjusted within a range allocated by the FBA scheme at the time of the startup. Therefore, in the PON system 1 of the present embodiment, the buffering latency in the ONU 3 is 0 msec, and communication of a REPORT, a GATE, etc. to the ONU 3 of a low-latency request is unnecessary; thus, as illustrated in FIG. 8, the total latency is 0.12 msec (jitter: 0 msec).

Therefore, in the PON system 1 at the time of the startup of the present embodiment, a low-latency guarantee can be achieved as compared to the PON system of the DBA scheme of the comparative example. In addition, the generation of unused unnecessary bands can be suppressed as compared to the PON system of the FBA scheme of the comparative example.

In the PON system of the DBA scheme of the comparative example, it is assumed that the second terminal is controlled over a core network and packets transmitted by the first terminal are transmitted in a certain band, a fixed packet cycle, and a fixed packet phase. At this time, factors by which packets are accumulated in the ONU accommodating the first terminal include the occurrence of not only deviation from the band but also differences between the cycle and phase in which packets from the first terminal arrive at the ONU and the cycle and phase in which the ONU transmits.

In the PON system of the DBA scheme of the comparative example, even if the band is optimized, the cycle difference and the phase difference are not adjusted; therefore, the buffering of packets due to the cycle difference and the phase difference will never become zero during operation. In other words, a latency due to buffering always has to be taken into account.

In contrast, in the PON system 1 of the present embodiment, allocation timing with which all arrival packets are allowed to be intermediate packets is set in the ONU 3 so that a latency due to buffering of the ONU 3 of a low-latency request does not occur. As a result, not only deviation from the band but also differences between the cycle and phase in which packets from the first terminal 2 arrive at the ONU 3 and the cycle and phase in which the ONU 3 transmits can be eliminated, and a low-latency guarantee can be achieved.

In order to secure a low-latency guarantee, also a PON system specialized for mobile fronthaul (MFH) is conceived as a comparative example. However, a PON system of such a comparative example is a scheme specialized for MFH, and is not able to be used for other systems of low-latency use cases (for example, remote medical care, autonomous driving, etc.) in which radio is not used. In addition, in the PON system of this comparative example, a special IF called CTI may be secured in the OLT.

In contrast, in the PON system 1 of the present embodiment, a general-purpose low-latency guarantee that does not need a special interface or protocol can be secured while the mechanism of an existing PON system is used as it is.

In the OLT 5 in the PON system 1 of the present embodiment, a case where allocation timing of, among a plurality of ONUs 3, an ONU 3 that has made a low-latency request is adjusted and allocated is given as an example. Then, the OLT 5 sequentially adjusts pieces of allocation timing of ONUs 3 in the order in which a low-latency request is made. In the case where, for example, low-latency requests are simultaneously made from two ONUs 3, the OLT 5 sequentially adjusts pieces of allocation timing of the ONUs 3 in a random order from the ONUs 3 that simultaneously made low-latency requests. At this time, although the buffering latency of one ONU 3 is 0 msec and the buffering latency of the other ONU 3 is 0.01 msec, the total latency is 0.13 msec (jitter: 0 msec). In short, although there is a possibility that a latency due to an accidental timing overlap will occur, this is much smaller than in the DBA scheme of the comparative example, and furthermore a jitter suppression effect can be expected.

As application examples of the present embodiment, the present embodiment can be applied to various applications of which low latency is needed, on the premise of traffic having periodicity.

In the PON system 1 of the present embodiment, an intermediate packet group including a plurality of intermediate packets or a head packet group including a plurality of head packets is given as an example. However, application is possible also to the case of an intermediate packet group of only a single intermediate packet or a head packet group including a single head packet.

Each constituent element of each unit illustrated in the drawings does not necessarily need to be physically configured as illustrated in the drawings. That is, specific forms of distribution and integration of the units are not limited to the forms illustrated in the drawings, and all or some of the units can be functionally or physically distributed or integrated in arbitrary units according to various loads, use condition, etc.

All or arbitrary ones of various processing functions performed by the devices may be executed on a central processing unit (CPU) (or a micro computer such as an micro processing unit (MPU), an micro controller unit (MCU), or a DSP). It goes without saying that all or arbitrary ones of the various processing functions may be executed on a program that is analyzed and executed by a CPU (or a micro computer such as an MPU or an MCU) or on hardware based on wired logic.

According to an aspect, a low-latency guarantee in a PON system can be secured.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical line terminal (OLT) used for a passive optical network (PON) using an optical splitter, the OLT comprising processing circuitry configured to:
collect time information regarding arrival of packets from an optical network unit (ONU) and amount-of-data information of the packets; and
determine transmission timing of the ONU based on transmission timing information allocated to the ONU, the time information, and the amount-of-data information.

2. The OLT according to claim 1, wherein
the processing circuitry is further configured to determine, from the transmission timing information and the time information, whether there is a packet that was transmitted at an allocation start time in one piece of timing allocated to the ONU or not.

3. The OLT according to claim 2, wherein
the processing circuitry is further configured to estimate a transmission allocation cycle of the ONU based on a determination result obtained by the determining, the time information, and the amount-of-data information.

4. The OLT according to claim 3, wherein
the processing circuitry is further configured to calculate a transmission allocation phase of the ONU from information of a time at which a packet that is determined in the determining to have been transmitted at an allocation start time in one piece of transmission timing allocated to the ONU arrived at the OLT.

5. The OLT according to claim 1, wherein
the processing circuitry is further configured to:
collect packet information including the time information and the amount-of-data information of arrival packets from the ONU connected to a terminal device, the arrival packets arriving within allocation timing allocated to the ONU;
determine, based on a collection result, whether the arrival packet is a head packet that arrives immediately after a start of the allocation timing or an intermediate packet that arrives during the allocation timing except immediately after a start of the allocation timing;
estimate, based on a determination result, an output cycle of the packets of the terminal device based on a head time of a first intermediate packet, a head time of a second intermediate packet, an amount of data of head packets between the first intermediate packet and the second intermediate packet, and an amount of data of the intermediate packet; and
calculate, based on the estimated output cycle, allocation timing to be allocated to the ONU.

6. The OLT according to claim 5, wherein
the processing circuitry is further configured to calculate, based on the output cycle, the allocation timing with which all head packets between the first intermediate packet and the second intermediate packet are turned to intermediate packets.

7. The OLT according to claim 5, wherein
the processing circuitry is further configured to,
in a case where a low-latency request from any ONU among a plurality of ONUs is detected, start an operation of collecting arrival packets that arrive within allocation timing allocated to the ONU that requests the low latency.

8. The OLT according to claim 5, wherein
the processing circuitry is further configured to estimate an output cycle of the packets of the terminal device by substituting a first head time of the first intermediate packet, a second head time of the second intermediate packet, an amount of data of head packets between the first intermediate packet and the second intermediate packet, and an amount of data of the first intermediate packet into a mathematical formula of {(second head time−first head time)/(integer value approximate to (amount of data of head packets/amount of data of first intermediate packet))+1}.

9. The OLT according to claim 8, wherein
the processing circuitry is further configured to,
in a case where the amount of data of the first intermediate packet and the amount of data of the second intermediate packet are approximate to each other, start an operation of estimating the output cycle.

10. The OLT according to claim 5, wherein
the processing circuitry is further configured to, after the allocation timing calculated by the calculating is allocated to the ONU, in a case where an event where an arrival packet in the allocation timing is determined as the intermediate packet appears consecutively a predetermined number of times, determine that the allocation timing is success.

11. The OLT according to claim 10, wherein
the processing circuitry is further configured to,
after the allocation timing calculated by the calculating is allocated to the ONU, in a case where an arrival packet in each piece of the allocation timing is determined as a head packet, determine that the allocation timing is failure.

12. The OLT according to claim 11, wherein
the processing circuitry is further configured to,
in a case where it is determined that the allocation timing is failure, increment a number of failures by +1, and resume a collection operation by the collecting packet information of arrival packets from the ONU that arrive within the allocation timing until the number of failures exceeds a predetermined number.

13. The OLT according to claim 5, wherein
the ONU
outputs an arrival packet to the OLT in a case where current timing is within allocation timing of itself, and buffers a packet that arrives in a case where the current timing is outside allocation timing of itself and outputs a buffered arrival packet to the OLT upon coming of a start of the allocation timing.

14. A passive optical network (PON) system comprising: an optical network unit (ONU) to be connected to a terminal device; and an optical line terminal (OLT) to be connected to a core network, the OLT performing optical communication of packets from the terminal device with the ONU, wherein
the OLT includes processing circuitry configured to:
collect time information regarding arrival of packets from the ONU and amount-of-data information of the packets; and
determine transmission timing of the ONU based on transmission timing information allocated to the ONU, the time information, and the amount-of-data information, and
the ONU,
based on the transmission timing allocated to the OLT, outputs an arrival packet from the terminal device to the OLT in a case where current timing is within transmission timing of itself, and buffers a packet that arrives from the terminal device in a case where the current timing is outside transmission timing of itself and outputs a buffered arrival packet to the OLT upon coming of a start of the transmission timing.
